(19) United States
(12) Patent Application Publication
(10) Pub. No.: US 2011/0188962 A1
(43) Pub. Date: Aug. 4, 2011

(54) SELF-ALIGNING FASTENER ASSEMBLY

(76) Inventor: David Alfred JOYCE, Billerica, MA (US)

(21) Appl. No.: 12/697,656

(22) Filed: Feb. 1, 2010

(51) Int. Cl. F16B 21/18

(52) U.S. Cl. 411/353

(57) ABSTRACT

A captive fastener assembly that employs a concentric collar protrusion protruds from the bottom circular edge of the screw hole, surrounds the lower transitional shaft of the fastener to hold the fastener steadily aligned with the receiving hole when the to-be-fastened parts as being opened or closed.

### FIELD OF THE INVENTION

The present invention relates to a fastener assembly that self-aligns the fastener to the fastener target hole during the operation when to-be-fastened parts are being opened or closed.

### BACKGROUND OF THE INVENTION

Typical captive fasteners, particularly captive screws, comprise a screw head, and a cylindrical, elongated screw body, with most of its lower part threaded with external treads. This type of fastener is typically used to fasten two to-be-fastened objects, one is herein called a holding part, and the other is called a target part. The holding part in existing fastener assemblies typically has a hole (hereinafter as ‘holding hole’) with a diameter that allows the fastener to be fit through. The interior surface of the holding hole may be threaded with interior threads mating the exterior threads on the fastener. Further, on the target part, there is also a hole (hereinafter as “target hole”) with a diameter that allows the fastener to be fit through. The interior surface of the target hole is also typically threaded with interior threads mating to the exterior threads on the fastener. The hole on the target part and the holding part are typically concentrically aligned to receive the fastener.

Such existing fasteners are typically threaded into the holding part until the bottom threaded portion on the fastener breaks through the far side surface of the holding part, thus holding the fastener by a transitional shaft between the threaded portion and the head of the fastener. The diameter of the transitional shaft of the captive fastener is smaller than the internal diameter of the threaded hole in both object and target parts to which the fastener is assembled.

This existing type of captive fastener especially poses a problem when retained in a hinged door manner that brings the head of the fastener initially into position at an off angle with respect to the direction for proper mating and thread engagement. As the door is tightened and brought into its fully seated position, the off angle is gradually eliminated; however, it can take considerable manipulation of the screw position to ensure that the threads are properly aligned before the door reaches the fully seated position. Wear-and-tear occurs to both the internal and external threads during this procedure.

The radial clearance between the fastener shaft and the holding hole allows movement (wiggling) of the fastener within the hole. This wiggling or freedom of movement causes an angular skew between the fastener center axis and the axis of the holding hole. The ability for the fastener to move becomes problematic when a user attempts to engage the fastener to the threaded target hole while trying to align the fastener with the target hole.

The problem is particularly acute for some screw assemblies when used for instruments or appliances where opening and closing of the screw fastened hinged parts are frequently needed.

Thus there has been an unmet need for a captive screw assembly that allows the screw to be held steadily and closely aligned with the target hole.

Existing efforts have been focused on the door hinge mechanism and the accuracy of the location of the holding and target holes. However, effective improvements have not been found to address the herein discussed alignment issue, particularly to remove the screw ‘wiggling’ issue.

### SUMMARY OF THE INVENTION

The invention disclosed herein aims to solve the problems related to captive fasteners, particularly to the misalignment between the fastener and the target hole of the fastener caused by the minor freedom of movement of the fastener.

Accordingly, it is a general object of the present disclosure to provide a captive fastener assembly that holds the fastener to be steadily and closely aligned with the target hole of the fastener for optimal mating thread alignment and engagement.

It is a further object of the present disclosure to provide a captive fastener assembly that employs a collar-like protrusion on the holding part surrounding the lower transitional shaft of the fastener to provide improved alignment of the fastener by limiting the angular skew of the fastener's center axis with respect to the center axis of the target hole.

It is further an object of the present disclosure to provide a captive fastener assembly that allows the fastener to be self-aligned with its target hole, which avoids the damages to the threads of both the fastener and the target hole.

It is further an object of the present disclosure to provide a captive fastener assembly that allows the fastener to be self-aligned with its target hole, therefore enhancing the efficiency of the fastening procedure.

One major novel aspect of present invention comprises a circular, collar-like protrusion extending outward from opposite side of the head of the fastener on the holding part containing a captive fastener. The circular protrusion contains an inner circular bore with a diameter larger than the threads of the captive fastener. The circular protrusion along with the inner bore forms a collar around the threads of the captive screw. This collar element is used in conjunction with the threaded holding hole to hold the fastener to be aligned with the target hole of the target part to be fastened. As the fastener transitions axially, the external threads of the fastener become confined by the inner wall of the collar thus limiting the amount of freedom the fastener can move radially. The restriction of movement by this inner bore keeps the fastener better aligned during the assembly process. The length, inside wall diameter, and outside wall diameter of the collar can vary depending on specific applications.

This collar-like protrusion does not interfere with the functionality of the captive fastener. The fastener maintains its rotational freedom and the ability to move along the axial direction as intended, allowing normal screw engagement and disengagement to and from the threaded target hole, respectively.

### BRIEF DESCRIPTION OF THE DRAWINGS

FIG. 1 is a cross-sectional view of the captive fastener assembly according to the present invention in a fully assembled (closed) condition.

FIG. 2 is another cross-sectional view of captive fastener assembly according to the present invention in a disassembled (open) condition.

### DETAILED DESCRIPTION OF THE INVENTION

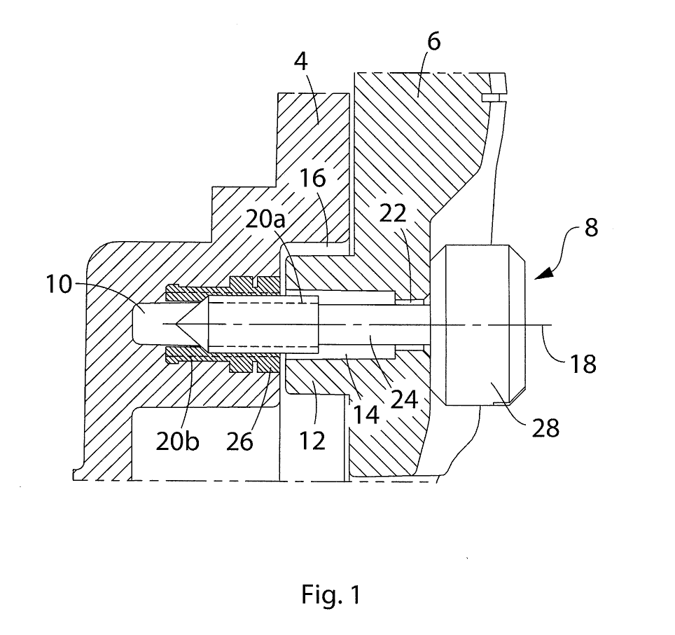

Referring to FIG. 1, the presently disclosed fastener assembly is comprised of a holding part 6 with a holding hole 22, a target part 4 with a target hole 10, a captive fastener 8, and a protruded collar 12.

Further, fastener 8 comprises a fastener head 28, a transitional shaft 24 and external threads 20a.

Target part 4 further comprises target hole 10 and interior threads 20b.

Fastener 8, holding hole 22 and target hole 10 are intended to be aligned along a common axis 18 when being under a closed condition.

As shown in FIG. 1, a fastener head 28 and a typical self-tapped or threaded holding hole 22 are conventionally used to hold a captive fastener 8 to a holding part 6. As a novel aspect of the present invention, the concentric protruded collar 12 and an inner circular bore 14 extend outward from the holding part 6 toward the target part 4. The diameter of circular bore 14 is preferably slightly greater in size than the outside diameter of the threads 20a. Providing this radial clearance ensures the intended function of the fastener 8 is not compromised. Normal axial movement of the fastener 8 along axis 18 and rotational movement of fastener 8 are not affected.

Angular deviation of the fastener 8 from the central axis 18 is minimized because of the limiting space allowed between fastener threads 20a and inner bore 14. Fastener 8 aligns itself, being held collectively by bore 14, head 28 and holding hole 22. This design results in an improved alignment of fastener 8 to target hole 10 in the target part 4 and ultimately a less cumbersome assembly procedure.

Collar 12 and bore 14 may be modified in both diameter and length based on the intended application. Preferably, the length of collar 12 should extend slightly over the threaded portion 20a of the fastener 8 when the fastener 8 is in a fully engaged position as shown in FIG. 1. This prevents the threads of the fastener near its transitional shaft 24 from catching on the end face of collar 12 when the fastener 8 is being disengaged. The depth of bore 14 is preferably long enough to allow full disengagement between threads of fastener 20a and target hole 10 before the holding part 6 and target part 4 begin to separate from each other.

A recess 16 is employed on target part 4 with a corresponding shape and location designed to accept collar 12.

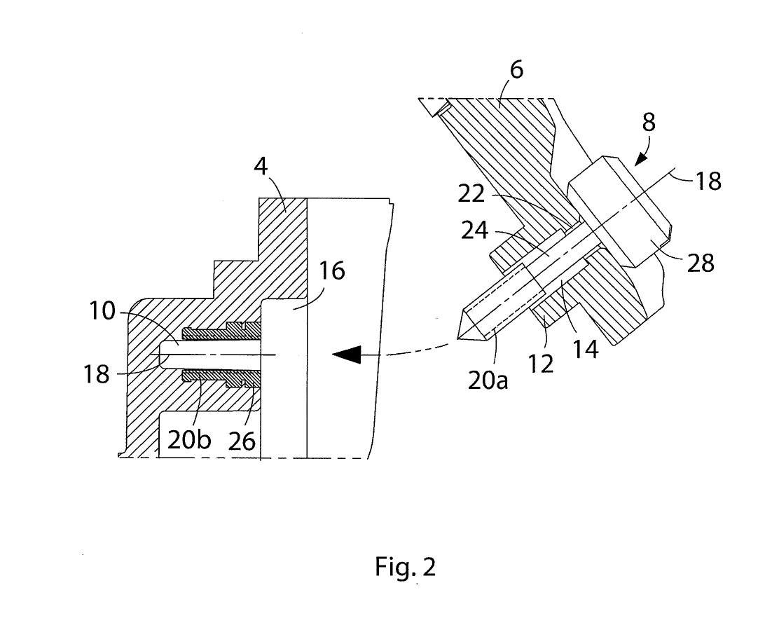

Internal threads 20b within the target hole 10 can either be machined into target part 4 or a threaded insert 26 can be employed as shown in FIGS. 1 and 2.

FIG. 2 illustrates the assembly in the ‘open’ position prior to assembly. The fastener 8 is threaded into holding part 6 until it becomes captive. Target part 4 includes a hole 10 with internal threads 20b possibly by the means of a separate part (i.e. threaded insert 26) to accept the fastener 8. Proper design and installation of the assembly insures threaded hole 10 & 20b of the target part 4, the captive fastener 8, and the holding part 6 are all concentric to one another along the common axis 18. Collar 12 and bore 14 of holding part 6 maintain the concentricity between fastener 8 and holding part 6.

As can be seen in FIG. 2, fastener 8 aligns itself to target hole 10, being held collectively by bore 14, head 28 and holding hole 22. The novel fastener assembly design with the extruded collar 12 and bore 14 allows fastener 8 to be concentrically inserted into hole 10, without damaging threads 20b. Threads of fastener 20a are free to move along common axis 18 and recede within bore 14 to avoid interference with target part 4 as collar 12 aligns and seats with recess 16. Once seated, the threads of fastener 20a are then free to move in the opposite direction to be fully screwed into internal threads 20b. The design also improves the efficiency of assembly procedure since it reduces the time it takes for operator to align fastener 8 and hole 10, or to locate hole 10.

Although the present invention has been described in relation to particular exemplary embodiments thereof, many other variations and modifications and other uses will become apparent to those skilled in the art. It is preferred, therefore, that the present invention not be limited by the specific disclosure.

What is claimed is:

1. A captive fastener assembly comprising,
a fastener having a head element and a fastener shaft,
a first structure having a holding hole, and,
a second structure having a target hole,
wherein the fastener is to hold the first and the second structures together when the fastener is mounted through the holding hole and the fastener shaft is inserted into the target hole; and,
the first structure further comprising a circular collar element protruding from the circular edge of the holding hole towards the second structure, wherein the collar element is concentric to that of the holding hole so that together with the head element and the holding hole, holds the fastener steadily concentric to the target hole.

2. The fastener assembly in claim 1, the second structure further comprising a recess with a shape corresponding to the shape of the collar element and at a location corresponding to the location of the collar element to allow the first structure and the second structure to be closely fastened together.

3. The fastener assembly in claim 1, wherein the fastener is a captive screw comprising external threads and the target hole comprising internal threads mating the external threads.

4. The fastener assembly in claim 3, wherein the length of the collar element is long enough so that the external threads are contained within the internal bore of the collar element when the fastener assembly is at a closed position.

5. The fastener assembly in claim 3, wherein the internal threads of the target hole is machined onto the internal surface of the target hole.

6. The fastener assembly in claim 3, wherein the internal threads are fabricated separately from of the target hole and are inserted into the target hole.

7. The fastener assembly in claim 1, wherein the collar element is molded together with the first structure during the fabrication of the first structure.

8. The fastener assembly in claim 1, wherein the collar element is machined onto the first structure during the fabrication of the first structure.
